(19) United States
(12) Patent Application Publication
(10) Pub. No.: US 2022/0335417 A1
(43) Pub. Date: Oct. 20, 2022

(54) Blockchain Non-Fungible Tokenization of Physical Assets Via Digital Twinning

(71) Applicant: VeriTX Corp., Buffalo, NY (US)

(72) Inventor: James Allen Regenor, East Aurora, NY (US)

(21) Appl. No.: 17/722,989

(22) Filed: Apr. 18, 2022

Related U.S. Application Data
(60) Provisional application No. 63/175,870, filed on Apr. 16, 2021.
(60) Provisional application No. 63/175,899, filed on Apr. 16, 2021.
(60) Provisional application No. 63/175,770, filed on Apr. 16, 2021.

(51) Int. Cl. G06Q 20/36

(52) U.S. Cl. CPC G06Q 20/3678

(57) ABSTRACT

Provided is a system and method for creating, maintaining and tracking a cryptographic digital asset tied to physical asset, including creating a digital asset file representative of a respective physical asset; initializing a digital asset generator to create a blockchain-enabled NFT having a unique digital asset ID code; linking the unique digital asset ID code with a unique user ID code which is associated with the first party; creating a first transaction block in a distributed blockchain ledger to record possession with the first party; receiving an asset transfer request to transfer the digital asset and physical asset to a second party; verifying a second unique user ID code; linking the cryptographic digital asset with the second unique user ID code; and creating a second transaction block in the distributed blockchain ledger for recordation of the transfer of possession from the first party to the second party.

### CROSS REFERENCE TO RELATED APPLICATIONS

The present application claims the benefit of priority to U.S. Provisional Patent No. 63/175,870, filed on Apr. 16, 2021 and entitled Blockchain non Fungible Tokens (NFTs) of Rotable Part Pool Management and Digital Twinning; U.S. Provisional Patent No. 63/175,899, filed on Apr. 16, 2021 and entitled Blockchain non Fungible Tokens (NFTs) of tools-equipment lockers Pool Management and Digital Twinning; and U.S. Provisional Patent No. 63/175,770, filed on Apr. 16, 2021 and entitled Blockchain non Fungible Tokens (NFTs) for Custody Verification and Track/Trace of Nuclear Warheads, Critical Nuclear Components, and Nuclear Fissible Materials, each of which is hereby incorporated by reference in its entirety.

### TECHNICAL FIELD

The present application relates generally to a computerized system and method for creating, distributing and/or monitoring cryptographically secured digital assets. Additionally, aspects of the application relate to decentralized computing systems and blockchain control logic.

### BACKGROUND

The need to identify, track and maintain equipment and materials vital to national security has only increased as global tensions continue to mount. Non-limiting examples of such equipment and materials include commercial and military aircraft, nuclear materials, as well as the parts and supplies needed to maintain such equipment and materials. Decentralized systems using blockchain technology provide for secure, verifiable and immutable asset management.

### SUMMARY

Briefly described, one aspect of the present invention provides for a method for creating, maintaining and tracking a cryptographic digital asset tied to physical asset. The method comprises creating, via a first computing node within a distributed computing network, a digital asset file representative of a respective physical asset in possession of a first party; initializing a digital asset generator to create a blockchain-enabled non fungible token (NFT) of the digital asset file, wherein the NFT is assigned a unique digital asset identification (ID) code; linking the unique digital asset ID code with a unique user ID code, wherein the unique user ID code is associated with the first party; creating a first transaction block including the unique digital asset code and the unique user ID code, via the first computing node in a distributed blockchain ledger, to record possession of the cryptographic digital asset and the respective physical asset with the first party; receiving an asset transfer request to transfer the cryptographic digital asset and respective physical asset to a second party; verifying a second unique user ID code which is associated with the second party; linking the cryptographic digital asset with the second unique user ID code; and creating a second transaction block including the unique digital asset ID code and the second unique user ID code in the distributed blockchain ledger for recordation of the transfer of possession of the cryptographic digital asset and the respective physical asset from the first party to the second party.

A further aspect of the present invention provides for a decentralized computing system for creating, maintaining and tracking a cryptographic digital asset tied to physical asset. The decentralized computing system comprises a cryptographic digital asset marketplace configured to store a plurality of digital assets and a plurality of unique digital asset identification (ID) codes; and a first computing node operatively connected to the cryptographic digital asset marketplace. The first computing node is programmed to: create a digital asset file representative of a respective physical asset in possession of a first party; initialize a digital asset generator to create a blockchain-enabled non fungible token (NFT) of the digital asset file, wherein the NFT is assigned a respective unique digital asset ID code; link the respective unique digital asset ID code with a unique user ID code, wherein the unique user ID code is associated with the first party; create a first transaction block including the respective unique digital asset ID code and the unique user ID code, via the first computing node in a distributed blockchain ledger, to record possession of the cryptographic digital asset and the respective physical asset with the first party; receive an asset transfer request to transfer the cryptographic digital asset and respective physical asset to a second party; verify a second unique user ID code which is associated with the second party; link the cryptographic digital asset with the second unique user ID code; and create a second transaction block including the respective unique digital asset ID code and the second unique user ID code in the distributed blockchain ledger for recordation of the transfer of possession of the cryptographic digital asset and the respective physical asset from the first party to the second party.

In another aspect of the present invention, an exemplary embodiment may be directed toward systems and methods to leverage blockchain Non Fungible Tokens (NFTs) to create a decentralized verifiable custody chain for aircraft tooling-equipment and other tools-equipment consigned or assigned to a tool/equipment locker for sign out and sign in accountability. An embodiment of the invention may allow for the tool/equipment provenance from initial sign-out to use to sign-in via a blockchain-enabled NFT. Blockchain smart contracts may be employed to define the terms and conditions of tool and equipment usage and for remuneration of fees to the part assigned or consigner per the tool locker contracts.

Additionally, the solution may leverage Verifiable Self Sovereign Identification (VSSI) and a key pair to secure to locker transactions for sign-out, use and sign-in. Whereas, users may be assigned a VSSI and the NFTs may record the transactions via VSSI and key pairing between the consigner and user in the tool locker. The NFT will provide a digital record of the sign-out, use, and sign-in of the tool or equipment flow and provide verifiable identity within the provenance and execution record of the transactions.

In a further aspect of the present invention, an exemplary embodiment may be directed toward providing systems and methods to leverage blockchain Non Fungible Tokens (NFTs) to create a decentralized verifiable custody chain for aircraft and other complex machinery parts consigned to a rotable pool. An exemplary embodiment of the invention allows for part provenance from initial requirements to full part lifecycle management via a blockchain enabled digital twin. This allows for the strict control procedures and processes needed to manage rotable pools between the vendors who consign their parts and the members/consumers of the rotables. Additionally, blockchain smart contracts may be employed to define the terms and conditions of the pool participation and for remuneration of fees to the part consigner per the rotable contracts.

Additionally, an aspect of the invention may leverage VSSI and a key pair to secure the rotable pool. That is, users may be assigned a VSSI and the NFTs may record the transactions via VSSI and key pairing between the consigner and consumer. The NFT may provide a digital record the execution flow and provided verifiable identity within the provenance and execution record of transactions.

In still another aspect of the present invention, an exemplary embodiment may be directed toward systems and methods to leverage blockchain Non Fungible Tokens (NFTs) to create a decentralized verifiable custody chain for Nuclear Warheads, Critical Nuclear Components, and Nuclear Fissible Materials. The invention may include an embodiment which allows for the creation and assembly of nuclear warheads and devices so that all the material, sub-component, and component parts' provenance will be embedded in a NFT construct. This may allow for the strict command and control procedures currently in place with the Department of Defense, Department of Energy and the National Nuclear Security Administration. The NFTs may create a vehicle to monitor regulatory compliance in an immutable manner while further enhancing security of the world's nuclear stockpiles. Additionally, this embodiment may provide the needed reporting procedures and transparency as defined in treaty provisions.

Each (nuclear) NFT may have blockchain transaction provenance traceable to individuals, organizations and assigned treaty provisions. This information may support Defense Threat Reduction Agency, Nuclear Regulatory, Air Force Safety Center, Department of Energy and NNSA Audit and Inspection requirements. Additionally, the fail-safe lock of the nuclear devices may be paired with Verifiable Self Sovereign Identification (VSSI) credentials to enhance nuclear security. Additionally, the solution may leverage VSSI and a key pair to secure the execution flow and provided verifiable identity within the provenance and execution record of transactions.

### BRIEF DESCRIPTION OF THE DRAWINGS

FIG. 1 is a diagram of an exemplary decentralized computing system for creating, distributing and/or monitoring cryptographically secured digital assets in accordance with an aspect of the present invention;

FIG. 2 is a flowchart showing an exemplary workflow algorithm for creating, distributing and/or monitoring cryptographically secured digital assets protected by cryptographic tokens on a blockchain ledger, which may correspond to memory-stored instructions executed by control-logic circuitry, programmable electronic control unit, or other computer-based device or network of devices in accordance with an aspects of the present invention;

FIG. 3 is an illustration of an exemplary workflow for managing tools and/or equipment through tokenization of cryptographic digital assets in accordance with an aspects of the present invention;

FIG. 4 is an illustration of an exemplary workflow for managing rotable part pools using tokenization of cryptographic digital assets in accordance with an aspects of the present invention; and

FIG. 5 is an illustration of an exemplary tokenization of nuclear materials for custody verification and tracking in accordance with an aspects of the present invention.

### DETAILED DESCRIPTION

As used herein, the terms “cryptographic digital assets,” and/or “digital assets” may refer to any computer-generated virtual object that has a unique, non-fungible tokenized code (“token”) registered on and validated by a blockchain platform or otherwise registered in an immutable database.

As described in greater detail below, each unique token (NFT) may be directly linked to a single physical object or asset, which may be reproduced as a virtual reproduction or digital version. In one embodiment, the token may include a 64-bit alphanumeric code that is sectioned into individual code segments where one or more or all of the code segments of the alphanumeric code may express data indicative of attributes of the physical asset or asset location or ownership. During the creation of each token, a smart contract may be generated to authenticate ownership and to track future transactions of the token on a blockchain-based distributed computing platform.

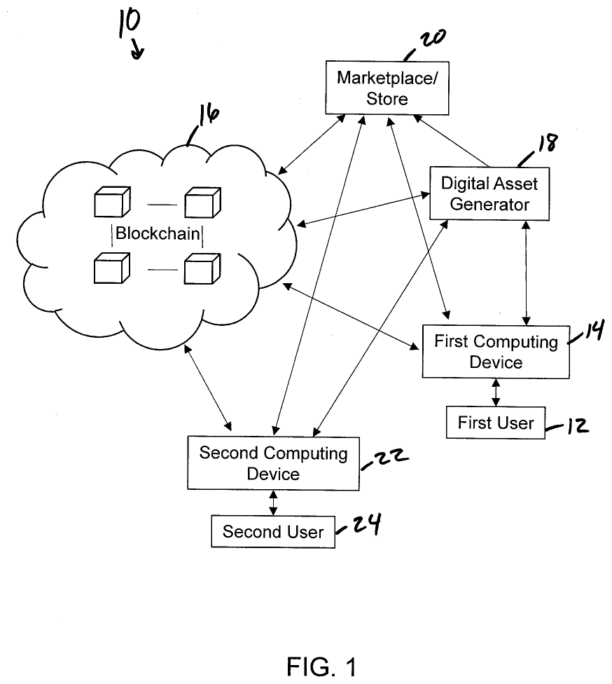

Referring now to the drawings, FIG. 1 shows an exemplary decentralized computing system 10 in accordance with the present invention. Decentralized computing system 10 includes blockchain control logic for mining, intermingling, and exchanging blockchain-enabled digital assets. As shown in FIG. 1, a first user 12 may operatively interface with a first computing device 14, such as but not limited to one or more of a smart phone, smart watch, a tablet, laptop or desktop computer, or other similar devices. First computing device 14 may be operatively configured to communicate with blockchain network 16. Blockchain network 16 is an immutable public database. First computing device may further operatively communicate with digital asset generator 18 and digital marketplace/store 20.

In one aspect of the invention, blockchain network 16 may include at least one non-fungible token (NFT) registered thereon which represents a tangible physical asset. The NFT may be generated via digital asset generator 18 and may include genomic information regarding the physical asset, such as but not limited to the location and owner of the physical asset, the part or serial number of the physical asset, the condition of the physical asset, and the like. First user 12 also possesses a digital wallet or locker that includes a private cryptographic key associated solely with first user 12. This unique key (user ID) allows first user 12, through first computing device 14, to read encrypted data associated with a linked token as well as enable transfer of ownership of the NFT. It should be noted that a cryptocurrency wallet/locker is used to store public and private key pairs but does not store the cryptocurrency itself. Instead, the cryptocurrency is decentralized and maintained in a publicly available blockchain ledger. With the stored keys, first user 12 may digitally sign a transaction and write it to the blockchain ledger. In one aspect of the present invention a smart contract associated with the wallet/locker may be used to automatically transfer assets and create a verifiable audit trail of every transfer.

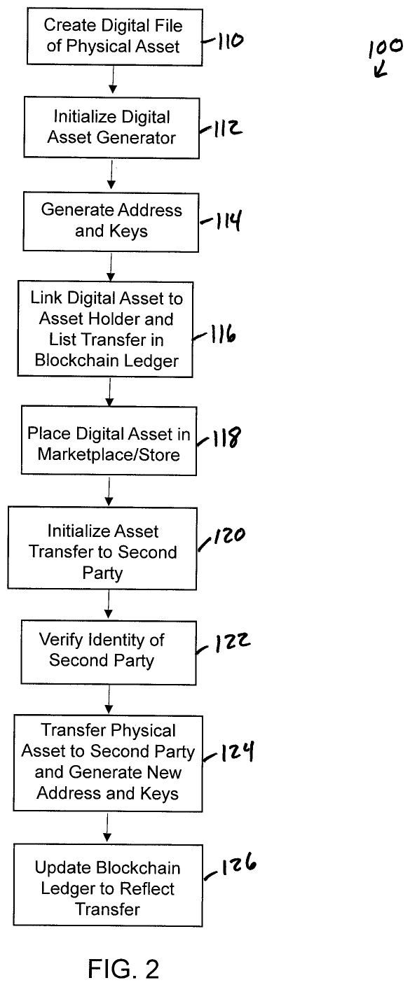

Turning now to FIG. 2, a method 100 for creating, maintaining and tracking a cryptographic digital asset tied to physical asset in accordance with an aspect of the present invention is shown. Some or all of the operations of the algorithm constituting method 100 may be processor-executable instructions stored in a memory and executable via a central processing unit (CPU), control logic circuit, or other module or device or network of devices. Unless expressly stated otherwise or required by logic, it should be understood by those skilled in the art that the order of execution of the steps of method 100 may be changed and that steps may be added, modified, combined, or deleted so long as the resultant method performs as intended herein.

As shown in FIG. 2, method 100 begins at step 110 with the creation of a digital file of the physical asset, such as but not limited to, a digital photograph which may then be stored in the memory of first computing device 14. First computing device 14 may then be used by first user 12 at step 112 to issue processor-executable instructions to initialize digital asset generator 18 to generate a cryptographic digital asset. The digital asset is generated as an NFT as described above and includes a unique digital asset ID code and any genomic information entered by first user 12 at step 114. At step 116, the unique digital asset ID code is linked with the unique user ID code of first user 12 and a first transaction block is created in a distributed blockchain ledger in blockchain network 16. The blockchain ledger thereby records possession of the cryptographic digital asset and the respective physical asset with first user 12. The digital asset may then be placed within a digital marketplace or store at step 118 whereby possession and/or ownership of the digital asset and physical asset may be freely transferred to a second party.

As shown at step 120, a second user 22 using a second computing device 24, such as smartphone or smartwatch (see FIG. 1) may access the digital marketplace 20 to initiate transfer of the digital asset and its associated physical asset. Second user 22 enters personal information (i.e., a user ID and associated blockchain locker/wallet) which is then verified and validated (step 122). Upon validation, the digital (and physical) asset is transferred from first user 12 to second user 24 whereby the digital asset receives a unique, encrypted asset code with an address, a token, and a public and private key pair (step 124) which is the added to the blockchain ledger at step 126.

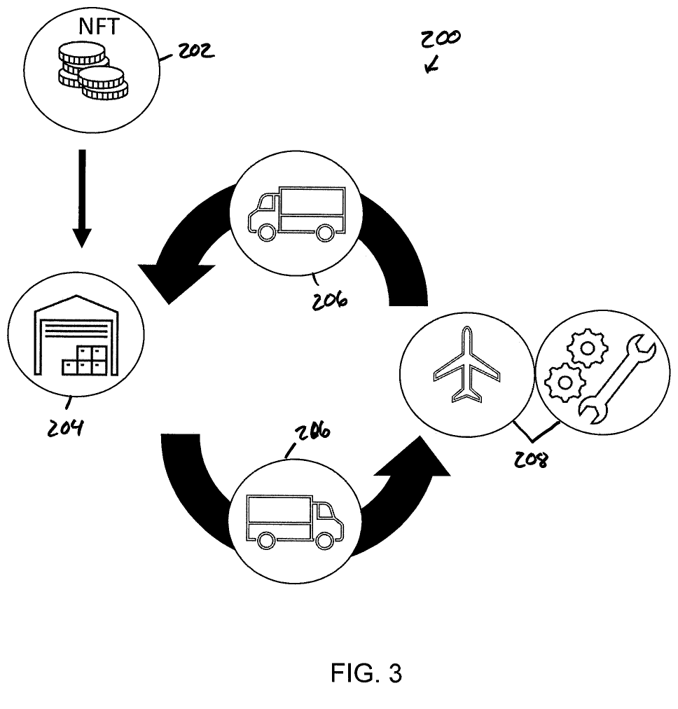

Turning now to FIG. 3, a first embodiment of an exemplary system configured to use system 10 and method 100 is generally references as system 200. System 200 uses tokenized tools and equipment 202 consigned or assigned to a common location or locker 204 for sign-out and sign-in accountability. System 200 allows for the tool and equipment provenance from initial sign-out to use to sign-in via blockchain enabled NFTs 202. The physical tools and equipment are digitally twinned to create digital asset files to enable monitoring of the cycles and use of the tools and equipment. Tokenization of the physical items allows for the implementation of strict control procedures and processes needed to manage the tools and equipment between vendors 206 who assign or consign their tools and equipment to locker 204 for use in maintenance and repairs of aircraft 208.

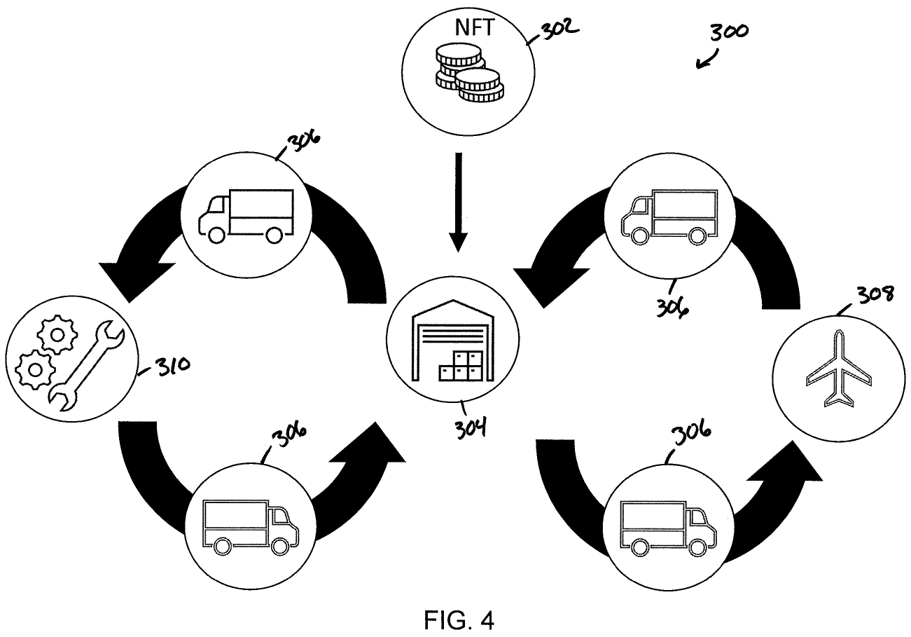

With reference to FIG. 4, an alternative system 300 configured to use system 10 and method 100 is shown. System 300 is directed to a decentralized verifiable custody chain for aircraft and other complex machinery parts 302 consigned to a rotable pool 304. Similar to system 200 described above, system 300 allows for the implementation of strict control procedures and processes needed to manage the rotable parts between vendors 306 who assign or consign their parts to pool 304 for use in maintenance and repairs of aircraft 308, as well as to monitor and manage repairs to such rotable parts by third party repair technicians 310.

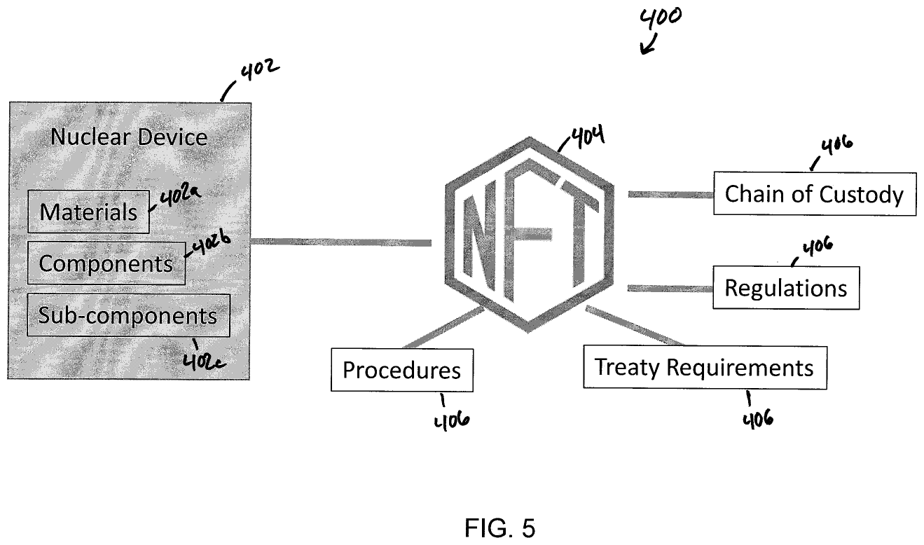

As shown in FIG. 5, exemplary system 400 is configured to use system 10 and method 100 to create a decentralized verifiable custody chain for nuclear devices 402 including warheads, critical nuclear components, and nuclear fissile materials through creation of unique NFTs 404. In one aspect of the invention, an exemplary embodiment of system 400 allows for the creation and assembly of nuclear warheads and devices 402 so that all the material 402a, sub-component 402b, and component 402c parts' provenance will be embedded in a non-Fungible Token (NFT) construct 404. NFTs 404 allow for the strict command and control procedures 406 currently in place with the Department of Defense, Department of Energy and the National Nuclear Security Administration, as well as create a vehicle to monitor regulatory compliance in an immutable manner while further enhancing security of the world's nuclear stockpiles. Additionally, system 400 may provide the needed reporting procedures and transparency as defined in treaty provisions. Additionally, the fail-safe lock of the devices 402 can be paired with verifiable self-sovereign identification (VSSI) credentials to enhance nuclear security.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, bubble memory, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software or a combination thereof, in a computer system or other processing system.

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a CD-ROM, a floppy disk, a hard drive, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms are described with reference to flowcharts depicted herein, many other methods for implementing the example machine-readable instructions may alternatively be used.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “comprising,” “having,” “containing,” and the like shall each mean “including without limitation.” Moreover, words of approximation, such as “about,” “almost,” “substantially,” “approximately,” and the like, may be used herein in the sense of “at, near, or nearly at,” or “within 0-5% of,” or “within acceptable manufacturing tolerances,” or any logical combination thereof, for example.

Furthermore, relative positional or directional terms used herein, such as for example, top, bottom, front, back, left side, right side, upward, downward, rightward, leftward, inward, outward, vertical, horizontal, clockwise, counterclockwise, etc., may have been used in the above-referenced description to describe a positional or directional relationship among elements as the elements are presented in the drawings. However, these terms should not limit in any way a specific orientation of the referenced feature, in practice.

Although the present invention has thus been described in detail with regard to the preferred embodiments and drawings thereof, it should be apparent to those skilled in the art that various adaptations and modifications of the present invention may be accomplished without departing from the spirit and the scope of the invention. Accordingly, it is to be understood that the detailed description and the accompanying drawings as set forth hereinabove are not intended to limit the breadth of the present invention, which should be inferred only from the following claims and their appropriately construed legal equivalents.

What is claimed is:

1. A method for creating, maintaining and tracking a cryptographic digital asset tied to physical asset, the method comprising:
creating, via a first computing node within a distributed computing network, a digital asset file representative of a respective physical asset in possession of a first party;
initializing a digital asset generator to create a blockchain-enabled non fungible token (NFT) of the digital asset file, wherein the NFT is assigned a unique digital asset identification (ID) code;
linking the unique digital asset ID code with a unique user ID code, wherein the unique user ID code is associated with the first party;
creating a first transaction block including the unique digital asset code and the unique user ID code, via the first computing node in a distributed blockchain ledger, to record possession of the cryptographic digital asset and the respective physical asset with the first party;
receiving an asset transfer request to transfer the cryptographic digital asset and respective physical asset to a second party;
verifying a second unique user ID code which is associated with the second party;
linking the cryptographic digital asset with the second unique user ID code; and
creating a second transaction block including the unique digital asset ID code and the second unique user ID code in the distributed blockchain ledger for recordation of the transfer of possession of the cryptographic digital asset and the respective physical asset from the first party to the second party.

2. The method of claim 1, wherein the transfer of possession is automatically initiated via a smart contract.

3. The method of claim 1, wherein the physical asset is selected from the list consisting of a nuclear device, a component of a nuclear device, a sub-component of a nuclear device and a nuclear material.

4. The method of claim 1, wherein the physical asset is an aircraft component, sub-component or part assigned to a rotable pool.

5. The method of claim 1, wherein the physical asset is a tool or piece of equipment assigned to a common locker accessible by both the first and second party.

6. A decentralized computing system for creating, maintaining and tracking a cryptographic digital asset tied to physical asset, the decentralized computing system comprising:
a cryptographic digital asset marketplace configured to store a plurality of digital assets and a plurality of unique digital asset identification (ID) codes; and
a first computing node operatively connected to the cryptographic digital asset marketplace, the first computing node being programmed to:
create a digital asset file representative of a respective physical asset in possession of a first party;
initialize a digital asset generator to create a blockchain-enabled non fungible token (NFT) of the digital asset file, wherein the NFT is assigned a respective unique digital asset ID code;
link the respective unique digital asset ID code with a unique user ID code, wherein the unique user ID code is associated with the first party;
create a first transaction block including the respective unique digital asset ID code and the unique user ID code, via the first computing node in a distributed blockchain ledger, to record possession of the cryptographic digital asset and the respective physical asset with the first party;
receive an asset transfer request to transfer the cryptographic digital asset and respective physical asset to a second party;
verify a second unique user ID code which is associated with the second party;
link the cryptographic digital asset with the second unique user ID code; and
create a second transaction block including the respective unique digital asset ID code and the second unique user ID code in the distributed blockchain ledger for recordation of the transfer of possession of the cryptographic digital asset and the respective physical asset from the first party to the second party.
